(19) United States
(12) Patent Application Publication
(10) Pub. No.: US 2023/0246682 A1
(43) Pub. Date: Aug. 3, 2023

(54) INFORMATION COMMUNICATION METHOD AND APPARATUS, COMMUNICATION DEVICE AND STORAGE MEDIUM

(71) Applicant: BEIJING XIAOMI MOBILE SOFTWARE CO., LTD., Beijing (CN)

(72) Inventor: Yang LIU, Beijing (CN)

(21) Appl. No.: 18/012,133

(22) PCT Filed: Jul. 14, 2020
(86) PCT No.: PCT/CN2020/101977

§ 371 Date: Dec. 21, 2022

(51) Int. Cl. H04B 7/06; H04B 7/0404; H04B 7/08; H04B 17/327

(52) U.S. Cl. CPC H04B 7/0608; H04B 7/0404; H04B 7/0802; H04B 17/327

(57) ABSTRACT

An information communication method includes receiving multi-antenna selection reference information sent by a base station; and determining antenna combinations for wireless communication based on the multi-antenna selection reference information. An apparatus, communication equipment and a storage medium for executing the method are also disclosed.

### CROSS-REFERENCE TO RELATED APPLICATION

The present application is a national phase entry under 35 USC § 371 of International Application PCT/CN2020/101977, filed Jul. 14, 2020, the entire contents of which are incorporated herein by reference.

### TECHNICAL FIELD

The present disclosure relates to, but is not limited to, a field of wireless communication technology, and more particularly to an information communication method, an information communication apparatus, a communication device and a storage medium.

### BACKGROUND

For non-millimeter-wave frequency bands, more antennas are provided on a multi-mode user equipment (UE). For example, four, six, or eight antennas may be provided on the multi-mode UE. For millimeter-wave frequency bands, the multi-antenna design of the multi-mode user equipment is a multi-panel antenna design. The more antennas, the higher the associated hardware cost other than the antenna cost is. For example, if the multi-mode UE needs to obtain a diversity gain of downlink four antennas in a certain mode, the multi-mode UE is required to support simultaneous reception from four antennas. For 4-antenna reception, the multi-mode UE is provided with additional baseband hardware processing units, such as channel estimation, signal processing, and control, which increases costs.

### SUMMARY

In view of this, embodiments of the present disclosure provide an information communication method, an information communication device, a communication device, and a storage medium.

According to a first aspect of embodiments of the present disclosure, an information communication method is provided. The information communication method is applied to a user equipment (UE), and includes receiving multi-antenna selection reference information sent by a base station; and determining antenna combinations for wireless communication based on the multi-antenna selection reference information.

According to a second aspect of embodiments of the present disclosure, an information communication method is provided. The information communication method is applied to a base station and includes sending multi-antenna selection reference information to a user equipment (UE). The multi-antenna selection reference information is configured to determine antenna combinations for wireless communication by the UE.

According to a third aspect of embodiments of the present disclosure, an information communication method is provided. The information communication method is applied to a server and includes receiving a second message of at least one UE that is sent by a base station and configured to identify at least two antenna combinations and reception quality parameters.

According to a fourth aspect of embodiments of the present disclosure, a communication device is provided. The communication device includes a processor; and a memory for storing executable programs capable of being run by the processor. The processor is configured to execute the executable programs to perform steps of the information communication method according to any one of embodiments of the first aspect, the second aspect and the third aspect.

According to a fifth aspect of embodiments of the present disclosure, a storage medium is provided. The storage medium has stored therein executable programs that, when executed by a processor, cause the processor to perform steps of the information communication method according to any one of embodiments of the first aspect, the second aspect and the third aspect.

It is to be understood that both the foregoing general description and the following detailed description are illustrative and explanatory only and are not intended to limit the embodiments of the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a schematic diagram illustrating a communication system according to an illustrative embodiment.

FIG. 2 is a schematic diagram illustrating an antenna selection according to an illustrative embodiment.

FIG. 3 is a flowchart illustrating an information communication method according to an illustrative embodiment.

FIG. 4 is a schematic diagram illustrating an antenna selection according to another illustrative embodiment.

FIG. 5 is a flowchart illustrating an information communication method according to another illustrative embodiment.

FIG. 6 is a flowchart illustrating an information communication method according to another illustrative embodiment.

FIG. 7 is a block diagram illustrating an information communication apparatus according to an illustrative embodiment.

FIG. 8 is a block diagram illustrating an information communication apparatus according to another illustrative embodiment.

FIG. 9 is a block diagram illustrating an information communication apparatus according to another illustrative embodiment.

FIG. 10 is a block diagram illustrating a device for information communication according to an illustrative embodiment.

### DETAILED DESCRIPTION

Reference will now be made in detail to illustrative embodiments, examples of which are illustrated in the accompanying drawings. The following description refers to the accompanying drawings in which the same numbers in different drawings represent the same or similar elements unless otherwise represented. The implementations set forth in the following description of illustrative embodiments do not represent all implementations consistent with the disclosure. Instead, they are merely examples of apparatuses and methods consistent with aspects related to embodiments of the disclosure as recited in the appended claims.

Terms used in embodiments of the present disclosure are for describing some embodiments only, and are not intended to limit the embodiments of the present disclosure. As used in embodiments of the present disclosure and the appended claims, “a/an”, “said” and “the” in singular forms are also intended to include plural forms unless the context clearly indicates otherwise. It could also be understood that the term “and/or” as used herein refers to and includes any and all possible combinations of one or more associated listed items.

It could be understood that although the embodiments of the present disclosure may use the terms “first”, “second”, “third”, etc. to describe various information, but the information is not limited to these terms. These terms are only used to distinguish information of the same type from each other. For example, without departing from the scope of embodiments of the present disclosure, first information may also be called second information, and similarly second information may also be called first information. Depending on the context, the word “if” as used herein may be interpreted as “upon” or “when” or “in response to determining”.

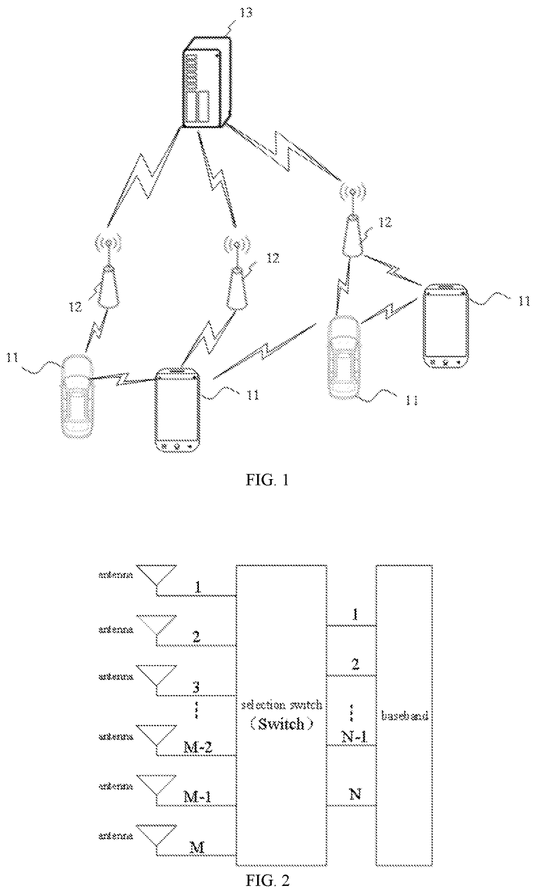

FIG. 1 is a schematic diagram illustrating a wireless communication system in some embodiments of the present disclosure. As shown in FIG. 1, the wireless communication system is a communication system based on cellular mobile communication technology, and the wireless communication system may include several terminals 11 and several base stations 12.

The terminal 11 may be a device that provides voice and/or data connectivity to a user. The terminal 11 may communicate with one or more core networks via a radio access network (RAN). The terminal 11 may be an Internet of Things terminal, such as a sensor device, a mobile phone (or called a “cellular” phone) and a computer having an Internet of Things terminal. For example, the terminal 11 may be a fixed, portable, pocket, hand-held, built-in computer or vehicle-mounted device. For example, the terminal 11 may be a station (STA), a subscriber unit, a subscriber station, a mobile station, a mobile, a remote station, an access point, a remote terminal, an access terminal, a user terminal, a user agent, a user device, or a user equipment (UE). Alternatively, the terminal 11 may be a device of an unmanned aerial vehicle. Alternatively, the terminal 11 may be a vehicle-mounted device, for example, a trip computer with a wireless communication function, or a wireless communication device externally connected to the trip computer. Alternatively, the terminal 11 may also be a roadside device, for example, it may be a street lamp, a signal lamp, or other roadside devices with a wireless communication function.

The base station 12 may be a network side device in a wireless communication system. The wireless communication system may be the fourth generation mobile communication technology (4G) system, also known as a long term evolution (LTE) system. Alternatively, the wireless communication system may also be the fifth generation mobile communication technology (5G) system, also called a new radio (NR) system or 5G NR system. Alternatively, the wireless communication system may also be a next generation system of the 5G system. An access network in the 5G system may be called a new generation-radio access network (NG-RAN). Alternatively, the wireless communication system may also be a MTC system.

The base station 12 may be an evolved base station (eNB) adopted in a 4G system. Alternatively, the base station 12 may also be a central distributed architecture base station (gNB) in the 5G system. When the base station 12 adopts a central distributed architecture, the base station 12 generally includes a central unit (CU) and at least two distributed units (DU). The central unit is provided with a protocol stack of a packet data convergence protocol (PDCP) layer, a radio link control (RLC) layer, or a media access control (MAC) layer. A protocol stack of a physical (PHY) layer is provided in the distributed unit. The specific implementation manner of the base station 12 is not be limited in embodiments of the present disclosure.

A wireless connection may be established between the base station 12 and the terminal 11 through a wireless air interface. In some embodiments, the wireless air interface is a wireless air interface based on the fourth generation mobile communication network technology (4G) standard. Alternatively, the wireless air interface is a wireless air interface based on the fifth generation mobile communication network technology (5G) standard. For example, the wireless air interface is a new radio. Alternatively, the wireless air interface may also be a wireless air interface based on a next generation mobile communication network technology standard based on 5G.

In some embodiments, an E2E (end to end) connection may also be established between terminals 11, such as a V2V (vehicle to vehicle) communication, a V2I (vehicle to infrastructure) communication and a V2P (vehicle to pedestrian) communication in vehicle to everything (V2X) communication scenes.

In some embodiments, the above-mentioned wireless communication system may further include a network management device 13.

Several base stations 12 are connected to the network management device 13 respectively. The network management device 13 may be a core network device in the wireless communication system. For example, the network management device 13 may be a mobility management entity (MME) in an evolved packet core network (EPC). Alternatively, the network management device may also be other core network devices, such as a serving gate way (SGW), a public data network gateway (PGW), a policy and charging rules function unit (PCRF) or a home subscriber server (HSS). The implementation form of the network management device 13 is not limited in embodiments of the present disclosure.

Execution entities involved in embodiments of the present disclosure include, but are not limited to, a wireless communication user equipment such as a mobile phone terminal with a plurality of antennas, and a base station.

An application scenario of the embodiments of the present disclosure is non-millimeter waves as an example. As shown in FIG. 2, a selection switch may be directly provided on antennas and baseband paths. The numberMof antennas is greater than the number N of baseband paths. The selection switch may select a certain number of antennas to be connected to the baseband. For example, only two antennas may be selected to be connected to the baseband. In this way, baseband cost may be saved, and baseband processing complexity may be reduced.

A static selection method is generally used to select an antenna to access the baseband, or a static selection method after comparing RSRP during initial access. The static selection method refers to adopting fixed antenna combinations for different frequency bands. The static selection method after comparing RSRP upon the initial access means that when the UE initially accesses the network, the UE compares the RSRPs of different antenna combinations and selects the antenna combination with the optimal RSPT, which will not change during the subsequent movement. Both methods are static selections, and cannot be dynamically adapted to changes in network conditions, so as to achieve optimal performance.

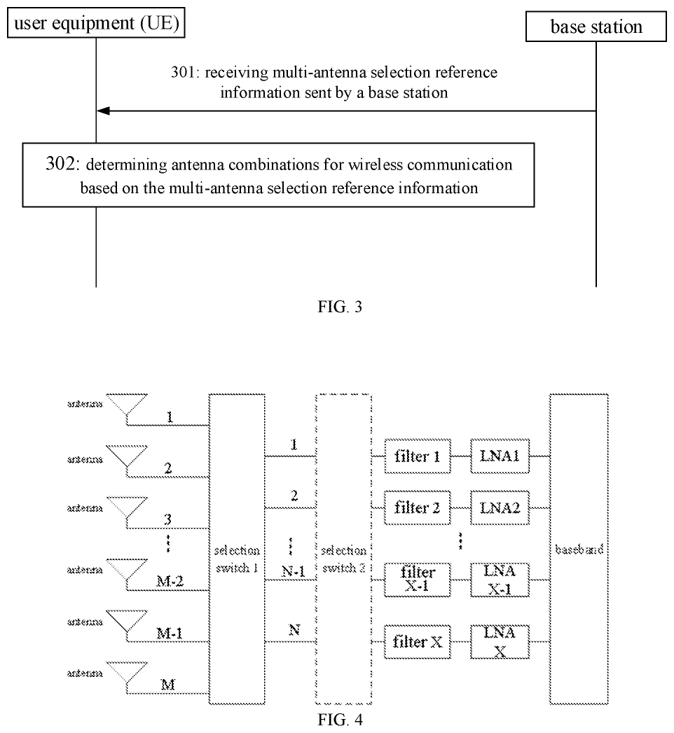

As shown in FIG. 3, an embodiment of the present disclosure provides an information communication method. The information communication method is applied to a user equipment (UE) for wireless communication, and includes the following step S301 to S302.

In step 301, multi-antenna selection reference information sent by a base station is received.

In step 302, antenna combinations for wireless communication are determined based on the multi-antenna selection reference information.

The UE may be a multi-mode UE such as a mobile phone terminal in cellular mobile communication. The multi-mode UE may be a UE that supports a plurality of frequency bands for communication, or supports different cellular mobile communication technologies.

The antenna may be a physical antenna, or an antenna array or an antenna unit in an antenna panel.

The antenna combination herein may be a MIMO antenna combination. An antenna combination may include at least two antennas. At least two antenna combinations may be all possible antenna combinations of the UE. Different antenna combinations may be all possible antenna combinations. The different antenna combinations may also be antenna combinations with a predetermined number of antennas, for example, the antenna combinations with the predetermined number of antennas may be all antenna combinations with the number of antennas being 2.

Different antenna combinations have different receiving capabilities for wireless signals of different frequency bands and/or different communication standards.

The multi-antenna selection information may be used to indicate a basis for the UE to select antenna combinations, such as massive multiple-input multiple-output (MIMO). The UE may select an antenna combination based on the multi-antenna selection information.

In some embodiments, the multi-antenna selection information may indicate a correspondence between different antenna combinations and reception performance. The UE may select the antenna combination with the optimum reception performance according to the correspondence between the antenna combinations and the reception performance.

The multi-antenna selection information may also be indication information directly indicating the antenna combinations. The UE may directly select the antenna combination according to the indication information. For example, the multi-antenna selection information may indicate that an optimal antenna combination under the current network includes antennas and/or signal receiving paths, and the UE may determine the antenna combination according to the indicated number of antennas.

In this way, the UE may select the antenna combination according to the multi-antenna selection information. On the one hand, the antenna combination performance test performed by the UE to select a suitable antenna combination from all antennas may be reduced, and the antenna combination selection efficiency may be improved. On the other hand, the base station may provide multi-antenna selection information adapted to the current network, such that the selected antenna combination may adapt to the current wireless communication, improve communication quality, and further improve communication reliability.

In some embodiments, antennas in any two different antenna combinations are not completely the same or are completely different, and/or signal receiving paths in any two different antenna combinations are not completely the same or are completely different.

The antennas in any two different antenna combinations may be different, or the antennas in any two different antenna combinations may be the same but the signal receiving paths connected to the antennas are different, or the antennas in any two different antenna combinations and the signal receiving paths connected to the antennas are different. The different antennas in different antenna combinations mean that the number of antennas is different, and/or the selected antennas are different.

As shown in FIG. 2, one antenna combination has less than or equal to N antennas, where N is less than or equal to the total number M of antennas of UE, and M and N are positive integers. The UE may have M antennas. The UE may select an antenna connected to a baseband through a selection switch between the antenna and the base station. The number of the antennas connected to the baseband may be less than or equal to N. Here, Nis less than or equal to the total number M of the antennas of the UE. For example, N may be the number of switch paths of the selection switch. Here, an antenna combination may be formed by selecting one or more antennas connected to the baseband through the selection switch between the antennas and the base station.

In some embodiments, if the UE has six antennas, when the number of the antennas in each antenna combination is one, six antenna combinations may be formed. When the number of the antennas in each antenna combination is two, fifteen antenna combinations may be formed. When the number of the antennas in each antenna combination is three, twenty antenna combinations may be formed.

As shown in FIG. 4, in a radio frequency front-end block diagram, the UE may have X signal receiving paths, where X is a positive integer greater than or equal to 1. The signal received by the antenna needs to be transmitted to the baseband through a signal receiving path composed of filters and/or low noise amplifiers and other devices. The signal receiving paths connected to each antenna may also be switched through the selection switch, such that one antenna may be connected to different signal receiving paths. Different signal receiving paths have different processing capabilities for signals in different frequency bands. An antenna connected to different signal receiving paths can make the RF front-end adapt to signals in different frequency bands. Here, the antennas in different antenna combinations may be the same, but the signal receiving paths connected to the antennas may be different, or the antennas in different antenna combinations and the signal receiving paths connected to the antennas may be different.

In some embodiments, receiving the multi-antenna selection reference information sent by the base station may include receiving system information carrying the multi-antenna selection reference information sent by the base station.

Here, the base station may broadcast the multi-antenna selection reference information carried in the system message. The UE may determine the used antenna combinations before access, thus improving a success rate of random access.

The base station may carry the multi-antenna selection reference information in the existing system information, for example, the multi-antenna selection reference information may be carried in an existing service independent building (SIB). In this way, the system information may carry more content, thus improving a utilization rate of the system information.

The base station may add an SIB for carrying multi-antenna selection reference information.

In some embodiments, the information communication method further includes sending a system information request to the base station.

Receiving the system information carrying the multi-antenna selection reference information sent by the base station includes receiving the system information carrying the multi-antenna selection reference information sent by the base station in response to the system information request.

Here, the system information request may be an on-demand system information request. Before random access, the UE may send the on-demand system information request to the base station. After receiving the on-demand system information request, the base station may broadcast or directly send the system information carrying the multi-antenna selection information to the UE.

The UE may determine the antenna combination according to the multi-antenna selection information carried in the system information.

The base station sends the system information carrying the multi-antenna selection information in response to the request, which may reduce resource overheads caused by continuously broadcasting the system information carrying the multi-antenna selection information.

In some embodiments, receiving the multi-antenna selection reference information sent by the base station at least includes receiving a first message sent by the base station for identifying at least two antenna combinations and corresponding reception quality parameters.

Determining the antenna combinations for the wireless communication based on the multi-antenna selection reference information includes determining the antenna combinations for the wireless communication according to the first message.

Different antenna combinations have their corresponding reception quality parameters. The reception quality parameters herein may be used to represent the quality of the wireless signals received by the UE. The reception quality parameter may include a received signal strength indication (RSSI) and/or a reference signal received power (RSRP) and the like.

The first message may indicate a correspondence between different antenna combinations and the corresponding reception quality parameters. The first message may be one or more correspondences between one or more different antenna combinations and their corresponding reception quality parameters.

In some embodiments, the first message may be in a form of a sequence, for example, {SSB-RSRP, antenna combination}, where SSB-PRSP represents RSRP of SSB measured by using the antenna combination in the expression.

The UE may determine the antenna combination used for an original wireless communication from the first message according to the desired reception quality parameter. The desired reception quality parameter herein may be the optimal reception quality parameter in a second message.

In this way, the UE may select the antenna combination according to the first message. On the one hand, the antenna combination performance test performed by the UE to select a suitable antenna combination from all antennas may be reduced, and the antenna combination selection efficiency may be improved. On the other hand, the base station may provide the first message adapted to the current network, such that the selected antenna combination may adapt to the current wireless communication, improve communication quality, and further improve communication reliability.

In some embodiments, the information communication method further includes determining reception quality parameters of the at least two antenna combinations; and sending a second message for identifying the at least two antenna combinations and the reception quality parameters determined to the base station. The second message is configured to determine the first message.

The UE may measure the reception quality parameters corresponding to different antenna combinations of the UE. The second message may indicate the correspondence between different antenna combinations of the UE and reception quality parameters measured for different antenna combinations. The second message may be sent to the base station by the UE, and then be forwarded to the server through the base station. The server may be a base station server, a core network server and the like. Alternatively, the server may be a server provided on a network such as a wide area network for processing data. The server may perform big data or AI processing.

The server may determine the first message based on the second message, which may be the same as or different from the first message.

The first message may be a result obtained by performing statistical processing on the second message. For example, for a plurality of received second messages, a plurality of reception quality parameters of the same antenna combination may be averaged or weighted averaged. The correspondence between different antenna combinations and the calculated reception quality parameters is determined as the first message. The second message herein may be the correspondence between one or more different antenna combinations and the reception quality parameters. The plurality of second messages may be second messages obtained by one UE through multiple measurements, and/or second messages obtained by multiple identical UEs through measurements. The identical UEs herein may be UEs with the same antenna design.

The server may update the first message according to the plurality of second messages reported by different UEs, or the plurality of second messages reported by the same UE. In this way, the correspondence between the antenna combinations and the reception quality parameters reflected in the first message is more accurate and more time-efficient. Therefore, using the first message to determine the antenna combination for signal communication may improve the accuracy of the antenna combination selection, thus improving communication quality.

In some embodiments, the second message is further configured to indicate a cell corresponding to the second message.

In different cells, the reception quality parameters measured for the same antenna combination are different. The second message sent by the UE to the base station and forwarded by the base station to the server may be identified with cell identification information, and the server may determine the cell corresponding to the second message based on the cell identification information. The cell identification information may be a cell identification (Cell ID).

In some embodiments, the second message may be in a form of a sequence, for example, {Cell-ID, SSB-RSRP, antenna combination}, where Cell-ID represents a cell corresponding to the second message, and SSB-PRSP represents RSRP of SSB measured by using the antenna combination in the expression.

By using the cell identification information to identify the second message, the server may determine the cell corresponding to the second message, such that the first message of the cell identified by the cell identification information may be determined.

In some embodiments, sending the second message for identifying the at least two antenna combinations and the reception quality parameters determined to the base station includes sending one or more second messages obtained by one or more times to the base station.

Due to changes in the wireless signal receiving environment, such as changes in surrounding interference conditions, the reception quality parameters measured by the UE at the same position will change.

The UE may perform one or more measurements to obtain a plurality of second messages. The UE may send the obtained second messages to the base station, and the base station may forward them to the server. Each second message herein may include the correspondence between different antenna combinations and the measured reception quality parameters.

After receiving the plurality of second messages, the server may determine reception quality parameters corresponding to different antenna combinations by performing statistical processing on the plurality of second messages to obtain the first message.

In this way, the accuracy of the first message of the reception quality parameters corresponding to different antenna combinations determined by the server may be improved.

In some embodiments, receiving the first message sent by the base station for identifying at least two antenna combinations and corresponding reception quality parameters includes receiving the first message sent by the base station for identifying the at least two antenna combinations and corresponding reception quality parameter index values. Different quality parameter index values represent different ranges of the reception quality parameters.

Usually, values of the reception quality parameters such as RSSI or RSRP are relatively discrete. For example, the receiving quality parameters corresponding to different antenna combinations in the first message may be different from the predetermined desired receiving quality parameters. As such, it may not be possible to determine the antenna combination from the first message using the desired reception quality parameters.

The reception quality parameters may be quantified herein. The server may use quality parameter index values to represent reception quality parameters in different ranges. The reception quality parameter index value may indicate a reception quality parameter within a range. The UE may predetermine the desired reception quality parameter index value, or select the desired reception quality parameter index value according to the quality of the reception quality parameters indicated by the reception quality parameter index values. For example, a reception quality parameter index value indicating an optimal reception quality parameter may be determined as the desired reception quality parameter index value. The antenna combination corresponding to the desired reception quality parameter index value is selected for signal communication.

The corresponding reception quality parameters are quantized, which may avoid the situation that the antenna combination cannot be determined from the first message.

In some embodiments, the reception quality parameter index values are obtained by rounding quotients that are obtained by dividing the reception quality parameters by a predetermined quantization constant.

Here, the reception quality parameter may be divided by the predetermined quantization constant to obtain the quotient, and the quotient is rounded to obtain the reception quality parameter index value. In this way, a reception quality parameter index value indicating a certain reception quality parameter range may be obtained.

In some embodiments, the number of the antenna combinations corresponding to one reception quality parameter index value is less than or equal to a preset number threshold.

If the difference between the reception quality parameters corresponding to different antenna combinations is small, the number of the reception quality parameters indicated by one reception quality parameter index value will be greater than one. That is, one reception quality parameter index value may correspond to multiple antenna combinations. The predetermined quantization constant may be adjusted to narrow the range of the reception quality parameter indicated by the reception quality parameter index value, such that the number of antenna combinations corresponding to one reception quality parameter index value is less than or equal to the preset number threshold. For example, the preset quantity threshold may be 2.

In some embodiments, as shown in Table 1, the same reception quality parameter index value, that is, one RSRP quantization value corresponds to two antenna combinations, that is, RSRP quantization value 1 corresponds to antenna combination 0 or 1. When the reception quality parameter index value selected by the UE is 1, two antenna combinations may be obtained.

TABLE 1

| RSRP quantization value | antenna combination |
|---|---|
| 0 | 0 |
| 1 | 1 or 0 |
| . . . | . . . |

In this way, after the UE determines the reception quality parameter index value, the number of antenna combinations for selection is less than or equal to the preset number threshold, and the frequency at which the UE selects antenna combinations is reduced.

In some embodiments, receiving the first message sent by the base station for identifying at least two antenna combinations and corresponding reception quality parameters includes receiving the first message in a current cell.

Determining the antenna combinations for the wireless communication according to the first message includes determining antenna combinations for wireless communication for the current cell according to the first message in the current cell.

The second message sent by the UE may use cell identification information to identify the cell. The server may determine the first messages in different cells based on the second messages in different cells.

The first message in the current cell of the UE is sent to the base station by the server, and is forwarded to the UE through the base station. The UE may determine the antenna combination suitable for the current cell based on the first message.

The server may determine the current cell of the UE based on the cell identity information used in the second message sent by the UE, or the UE may send indication information of the current cell to the server.

In some embodiments, the reception quality parameters include a reference signal received power (RSRP).

Here, the UE may measure RSRPs corresponding to different antenna combinations, and send the first message of the different antenna combinations and the RSRP to the server.

RSRP is an average value of RF transmission power of all reference signals in the passband, and is a parameter used to indicate strength of a wireless signal. Using RSRP as the reception quality parameter may more clearly reflect receiving capabilities of different antenna combinations.

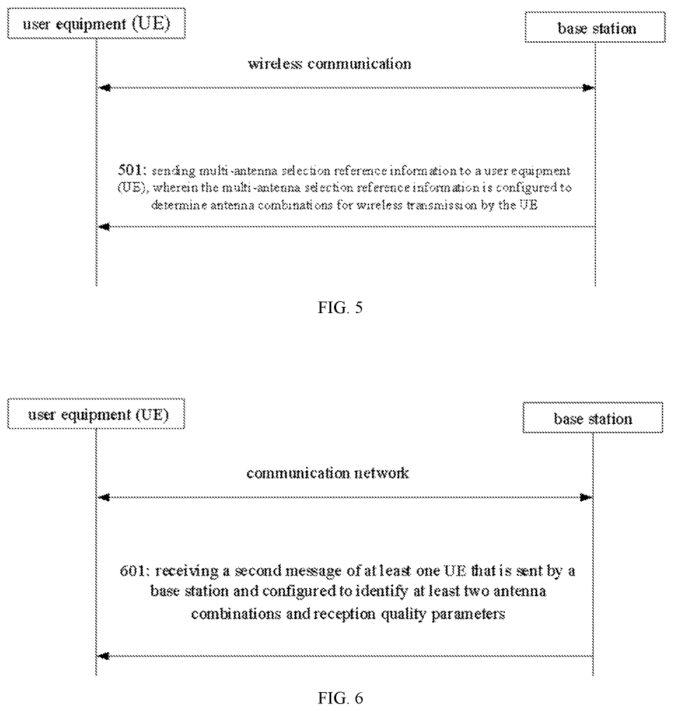

As shown in FIG. 5, an information communication method is provided. The information communication method is applied to a base station for wireless communication and includes the following step 501.

In step 501, multi-antenna selection reference information is sent to a user equipment (UE). The multi-antenna selection reference information is configured to determine antenna combinations for wireless communication by the UE.

The UE may be a multi-mode UE such as a mobile phone terminal in cellular mobile communication. The multi-mode UE may be a UE that supports a plurality of frequency bands for communication, or supports different cellular mobile communication technologies.

The antenna may be a physical antenna, or an antenna array or an antenna unit in an antenna panel.

The antenna combination herein may be a MIMO antenna combination. An antenna combination may include at least two antennas. At least two antenna combinations may be all possible antenna combinations of the UE. Different antenna combinations may be all possible antenna combinations. The different antenna combinations may also be antenna combinations with a predetermined number of antennas, for example, the antenna combinations with the predetermined number of antennas may be all antenna combinations with the number of antennas being 2.

Different antenna combinations have different receiving capabilities for wireless signals of different frequency bands and/or different communication standards.

The multi-antenna selection information may be used to indicate a basis for the UE to select antenna combinations, for example, a correspondence between different antenna combinations and reception performance. The UE may select the antenna combination with the optimum reception performance according to the correspondence between the antenna combinations and the reception performance.

The multi-antenna selection information may also be indication information directly indicating the antenna combinations. The UE may directly select the antenna combination according to the indication information. For example, the multi-antenna selection information may indicate that an optimal antenna combination under the current network includes antennas and/or signal receiving paths, and the UE may determine the antenna combination according to the indicated number of antennas.

In this way, the UE may select the antenna combination according to the multi-antenna selection information. On the one hand, the antenna combination performance test performed by the UE to select a suitable antenna combination from all antennas may be reduced, and the antenna combination selection efficiency may be improved. On the other hand, the base station may provide multi-antenna selection information adapted to the current network, such that the selected antenna combination may adapt to the current wireless communication, improve communication quality, and further improve communication reliability.

In some embodiments, antennas in any two different antenna combinations are not completely the same or are completely different, and/or signal receiving paths in any two different antenna combinations are not completely the same or are completely different.

The antennas in different antenna combinations may be different, or the antennas in different antenna combinations may be the same but the signal receiving paths connected to the antennas are different, or the antennas in different antenna combinations and the signal receiving paths connected to the antennas are different. The different antennas in different antenna combinations mean that the number of antennas is different, and/or the selected antennas are different.

As shown in FIG. 2, one antenna combination has less than or equal to N antennas, where Nis less than or equal to the total number M of antennas of UE, and M and N are positive integers. The UE may have M antennas. The UE may select an antenna connected to a baseband through a selection switch between the antenna and the base station. The number of the antennas connected to the baseband may be less than or equal to N. Here, Nis less than or equal to the total number M of the antennas of the UE. For example, N may be the number of switch paths of the selection switch. Here, an antenna combination may be formed by selecting one or more antennas connected to the baseband through the selection switch between the antennas and the base station.

In some embodiments, if the UE has six antennas, when the number of the antennas in each antenna combination is one, six antenna combinations may be formed. When the number of the antennas in each antenna combination is two, fifteen antenna combinations may be formed. When the number of the antennas in each antenna combination is three, twenty antenna combinations may be formed.

As shown in FIG. 4, in a radio frequency front-end block diagram, the UE may have X signal receiving paths, where X is a positive integer greater than or equal to 1. The signal received by the antenna needs to be transmitted to the baseband through a signal receiving path composed of filters and/or low noise amplifiers and other devices. The signal receiving paths connected to each antenna may also be switched through the selection switch, such that one antenna may be connected to different signal receiving paths. Different signal receiving paths have different processing capabilities for signals in different frequency bands. An antenna connected to different signal receiving paths can make the RF front-end adapt to signals in different frequency bands. Here, the antennas in different antenna combinations may be the same, but the signal receiving paths connected to the antennas may be different, or the antennas in different antenna combinations and the signal receiving paths connected to the antennas may be different.

In some embodiments, sending the multi-antenna selection reference information to the UE includes sending system information carrying the multi-antenna selection reference information to the UE.

Here, the base station may broadcast the multi-antenna selection reference information carried in the system message. The UE may determine the used antenna combinations before access, thus improving a success rate of random access.

The base station may carry the multi-antenna selection reference information in the existing system information, for example, the multi-antenna selection reference information may be carried in an existing SIB. In this way, the system information may carry more content, thus improving a utilization rate of the system information.

The base station may add an SIB for carrying multi-antenna selection reference information.

In some embodiments, the information communication method further includes receiving a system information request sent by the UE.

Sending the system information carrying the multi-antenna selection reference information to the UE includes sending the system information carrying the multi-antenna selection reference information to the UE in response to receiving the system information request.

Here, the system information request may be an on-demand system information request. Before random access, the UE may send the on-demand system information request to the base station. After receiving the on-demand system information request, the base station may broadcast or directly send the system information carrying the multi-antenna selection information to the UE.

The UE may determine the antenna combination according to the multi-antenna selection information carried in the system information.

The base station sends the system information carrying the multi-antenna selection information in response to the request, which may reduce resource overheads caused by continuously broadcasting the system information carrying the multi-antenna selection information.

In some embodiments, sending the multi-antenna selection reference information to the UE at least includes sending a first message for identifying at least two different antenna combinations and reception quality parameters to the UE.

Different antenna combinations have their corresponding reception quality parameters. The reception quality parameters herein may be used to represent the quality of wireless signals received by the UE. The reception quality parameter may include a received signal strength indication (RSSI) and/or a reference signal received power (RSRP) and the like.

In some embodiments, the first message may be in a form of a sequence, for example, {SSB-RSRP, antenna combination}, where SSB-PRSP represents RSRP of SSB measured by using the antenna combination in the expression.

The UE may determine the antenna combination used for an original wireless communication from the first message according to the desired reception quality parameter. The desired reception quality parameter herein may be the optimal reception quality parameter in a second message.

In this way, the UE may select the antenna combination according to the first message. On the one hand, the antenna combination performance test performed by the UE to select a suitable antenna combination from all antennas may be reduced, and the antenna combination selection efficiency may be improved. On the other hand, the base station may provide the first message adapted to the current network, such that the selected antenna combination may adapt to the current wireless communication, improve communication quality, and further improve communication reliability.

In some embodiments, the information communication method further includes receiving the first message sent by a server.

The server may be a base station server, a core network server and the like. Alternatively, the server may be a server provided on a network such as a wide area network for processing data. The server may perform big data or AI processing.

The server may determine the first message, and the first message may be forwarded to the UE through the base station.

In some embodiments, the information communication method further includes receiving a second message sent by the UE. The second message is configured to identify at least two antenna combinations and reception quality parameters of the at least two antenna combinations determined by the UE. The first message is determined based on the second message.

In some embodiments, the information communication method further includes sending the second message to the server.

The UE may measure the reception quality parameters corresponding to different antenna combinations of the UE. The second message may indicate the correspondence between different antenna combinations of the UE and reception quality parameters measured for different antenna combinations. The second message may be sent to the base station by the UE, and then be forwarded to the server through the base station. The server may be a base station server, a core network server and the like. Alternatively, the server may be a server provided on a network such as a wide area network for processing data. The server may perform big data or AI processing.

The server may determine the first message based on the second message, which may be the same as or different from the first message.

The first message may be a result obtained by performing statistical processing on the second message. For example, for a plurality of received second messages, a plurality of reception quality parameters of the same antenna combination may be averaged or weighted averaged. The correspondence between different antenna combinations and the calculated reception quality parameters is determined as the first message. The second message herein may be the correspondence between one or more different antenna combinations and the reception quality parameters. The plurality of second messages may be second messages obtained by one UE through multiple measurements, and/or second messages obtained by multiple identical UEs through measurements. The identical UEs herein may be UEs with the same antenna design.

The server may update the first message according to the plurality of second messages reported by different UEs, or the plurality of second messages reported by the same UE. In this way, the correspondence between the antenna combinations and the reception quality parameters reflected in the first message is more accurate and more time-efficient. Therefore, using the first message to determine the antenna combination for signal communication may improve the accuracy of the antenna combination selection, thus improving communication quality.

In some embodiments, the reception quality parameters include a reference signal received power (RSRP).

Here, the UE may measure RSRPs corresponding to different antenna combinations, and send the first message of the different antenna combinations and the RSRP to the server.

RSRP is an average value of RF transmission power of all reference signals in the passband, and is a parameter used to indicate strength of a wireless signal. Using RSRP as the reception quality parameter may more clearly reflect receiving capabilities of different antenna combinations.

As shown in FIG. 6, an information communication method is provided. The information communication method is applied to a server for wireless communication and includes the following step 601.

In step 601, a second message of at least one UE that is sent by a base station and configured to identify at least two antenna combinations and reception quality parameters is received.

The server may be a base station server, a core network server and the like. Alternatively, the server may be a server provided on a network such as a wide area network for processing data. The server may perform big data or AI processing.

The antenna may be a physical antenna, or an antenna array or an antenna unit in an antenna panel.

The UE may measure the reception quality parameters corresponding to different antenna combinations of the UE. The second message may indicate the correspondence between different antenna combinations of the UE and the reception quality parameters measured for different antenna combinations. The UE may send the second message to the base station, and the base station forwards the second message to the server.

The antenna combination herein may be a MIMO antenna combination. An antenna combination may include at least two antennas. At least two antenna combinations may be all possible antenna combinations of the UE. Different antenna combinations may be all possible antenna combinations. The different antenna combinations may also be antenna combinations with a predetermined number of antennas, for example, the antenna combinations with the predetermined number of antennas may be all antenna combinations with the number of antennas being 2.

Different antenna combinations have different receiving capabilities for wireless signals of different frequency bands and/or different communication standards.

The server may determine a signal reception condition of the UE according to the second message, and may adjust a communication network based on the second message. For example, the server may adjust a signal transmission state of the base station, or select an antenna combination suitable for a current network for the UE based on the second message, to reduce the load caused by the UE in selecting the antenna combination.

In this way, the UE reports the first message of different antenna combinations and the measured reception quality parameters to the server, such that the server may obtain the signal reception condition of the UE, which provides a basis for the server to indicate the UE to select an appropriate antenna combination or to adjust the communication network, and reduces the probability of blindly transmitting the antenna combinations or adjusting the communication network, thus improving communication reliability.

In some embodiments, antennas in different antenna combinations are not completely the same or are completely different, and/or signal receiving paths in the different antenna combinations are not completely the same or are completely different.

The antennas in different antenna combinations may be different, or the antennas in different antenna combinations may be the same but the signal receiving paths connected to the antennas are different, or the antennas in different antenna combinations and the signal receiving paths connected to the antennas are different. The different antennas in different antenna combinations mean that the number of antennas is different, and/or the selected antennas are different.

As shown in FIG. 2, one antenna combination has less than or equal to N antennas, where N is less than or equal to the total number M of antennas of UE, and M and N are positive integers. The UE may have M antennas. The UE may select an antenna connected to a baseband through a selection switch between the antenna and the base station. The number of the antennas connected to the baseband may be less than or equal to N. Here, Nis less than or equal to the total number M of the antennas of the UE. For example, N may be the number of switch paths of the selection switch. Here, an antenna combination may be formed by selecting one or more antennas connected to the baseband through the selection switch between the antennas and the base station.

In some embodiments, if the UE has six antennas, when the number of the antennas in each antenna combination is one, six antenna combinations may be formed. When the number of the antennas in each antenna combination is two, fifteen antenna combinations may be formed. When the number of the antennas in each antenna combination is three, twenty antenna combinations may be formed.

As shown in FIG. 4, in a radio frequency front-end block diagram, the UE may have X signal receiving paths, where X is a positive integer greater than or equal to 1. The signal received by the antenna needs to be transmitted to the baseband through a signal receiving path composed of filters and/or low noise amplifiers and other devices. The signal receiving paths connected to each antenna may also be switched through the selection switch, such that one antenna may be connected to different signal receiving paths. Different signal receiving paths have different processing capabilities for signals in different frequency bands. An antenna connected to different signal receiving paths can make the RF front-end adapt to signals in different frequency bands. Here, the antennas in different antenna combinations may be the same, but the signal receiving paths connected to the antennas may be different, or the antennas in different antenna combinations and the signal receiving paths connected to the antennas may be different.

In some embodiments, the information communication method further includes determining a first message of at least two antenna combinations and corresponding reception quality parameters based on the received second message of at least one UE.

The server may determine the first message based on the second message, which may be the same as or different from the first message.

The first message may be a result obtained by performing statistical processing on the second message. For example, for a plurality of received second messages, a plurality of reception quality parameters of the same antenna combination may be averaged or weighted averaged. The correspondence between different antenna combinations and the calculated reception quality parameters is determined as the first message. The second message herein may be the correspondence between one or more different antenna combinations and the reception quality parameters. The plurality of second messages may be second messages obtained by one UE through multiple measurements, and/or second messages obtained by multiple identical UEs through measurements. The identical UEs herein may be UEs with the same antenna design.

The server may update the first message according to the plurality of second messages reported by different UEs, or the plurality of second messages reported by the same UE. In this way, the correspondence between the antenna combinations and the reception quality parameters reflected in the first message is more accurate and more time-efficient. Therefore, using the first message to determine the antenna combination for signal communication may improve the accuracy of the antenna combination selection, thus improving communication quality.

In some embodiments, the information communication method further includes determining a cell corresponding to the second message according to an indication of the second message.

Determining the first message of at least two antenna combinations and corresponding reception quality parameters based on the received second message of at least one UE includes determining the first message of the cell corresponding to the second message according to the second message.

In different cells, the reception quality parameters measured for the same antenna combination are different. The second message sent by the UE to the base station and forwarded by the base station to the server may be identified with cell identification information, and the server may determine the cell corresponding to the second message based on the cell identification information. The cell identification information may be a cell identification (Cell ID).

In some embodiments, the second message may be in a form of a sequence, for example, {Cell-ID, SSB-RSRP, antenna combination}, where Cell-ID represents a cell corresponding to the second message, and SSB-PRSP represents RSRP of SSB measured by using the antenna combination in the expression.

By using the cell identification information to identify the second message, the server may determine the cell corresponding to the second message, such that the first message of the cell identified by the cell identification information may be determined.

In some embodiments, determining the first message of at least two antenna combinations and corresponding reception quality parameters based on the received second message of at least one UE includes determining the first message of at least two antenna combinations and corresponding reception quality parameter index values based on the second message. Different quality parameter index values represent different ranges of the reception quality parameters.

Usually, values of the reception quality parameters such as RSSI or RSRP are relatively discrete. For example, the receiving quality parameters corresponding to different antenna combinations in the first message may be different from the predetermined desired receiving quality parameters. As such, it may not be possible to determine the antenna combination from the first message using the desired reception quality parameters.

The reception quality parameters may be quantified herein. The server may use quality parameter index values to represent reception quality parameters in different ranges. The reception quality parameter index value may indicate a reception quality parameter within a range. The UE may predetermine the desired reception quality parameter index value, or select the desired reception quality parameter index value according to the quality of the reception quality parameters indicated by the reception quality parameter index values. For example, a reception quality parameter index value indicating an optimal reception quality parameter may be determined as the desired reception quality parameter index value. The antenna combination corresponding to the desired reception quality parameter index value is selected for signal communication.

The corresponding reception quality parameters are quantized, which may avoid the situation that the antenna combination cannot be determined from the first message.

In some embodiments, the reception quality parameter index values are obtained by rounding quotients that are obtained by dividing the reception quality parameters by a predetermined quantization constant.

Here, the reception quality parameter may be divided by the predetermined quantization constant to obtain the quotient, and the quotient is rounded to obtain the reception quality parameter index value. In this way, a reception quality parameter index value indicating a certain reception quality parameter range may be obtained.

In some embodiments, the number of the antenna combinations corresponding to one reception quality parameter index value is less than or equal to a preset number threshold.

If the difference between the reception quality parameters corresponding to different antenna combinations is small, the number of the reception quality parameters indicated by one reception quality parameter index value will be greater than one. That is, one reception quality parameter index value may correspond to multiple antenna combinations. The predetermined quantization constant may be adjusted to narrow the range of the reception quality parameter indicated by the reception quality parameter index value, such that the number of antenna combinations corresponding to one reception quality parameter index value is less than or equal to the preset number threshold. For example, the preset quantity threshold may be 2.

In some embodiments, as shown in Table 1, the same reception quality parameter index value, that is, one RSRP quantization value corresponds to two antenna combinations, that is, RSRP quantization value 1 corresponds to antenna combination 0 or 1. When the reception quality parameter index value selected by the UE is 1, two antenna combinations may be obtained.

In this way, after the UE determines the reception quality parameter index value, the number of antenna combinations for selection is less than or equal to the preset number threshold, and the frequency at which the UE selects antenna combinations is reduced.

In some embodiments, receiving the second message of at least one UE that is sent by the base station and configured to identify at least two antenna combinations and reception quality parameters includes receiving one or more of the second messages determined by the at least one UE for one or more times.

Due to changes in the wireless signal receiving environment, such as changes in surrounding interference conditions, the reception quality parameters measured by the UE at the same position will change.

The UE may perform one or more measurements to obtain a plurality of second messages. The UE may send the obtained second messages to the base station, and the base station may forward them to the server. Each second message herein may include the correspondence between different antenna combinations and the measured reception quality parameters.

After receiving the plurality of second messages, the server may determine reception quality parameters corresponding to different antenna combinations by performing statistical processing on the plurality of second messages to obtain the first message.

In this way, the accuracy of the first message of the reception quality parameters corresponding to different antenna combinations determined by the server may be improved.

In some embodiments, the information communication method further includes sending a first message to the base station. The first message is configured to determine the antenna combinations for wireless communication by the UE.

The server may send the first message to the base station, and the base station sends the first message to the UE.

In some embodiments, sending the first message to the base station includes sending a first message corresponding to a current cell of the UE to the base station. The first message is configured to determine antenna combinations for wireless communication in the current cell by the UE.

The second message sent by the UE may use cell identification information to identify the cell. The server may determine the first messages in different cells based on the second messages in different cells.

The first message in the current cell of the UE is sent to the base station by the server, and is forwarded to the UE through the base station. The UE may determine the antenna combination suitable for the current cell based on the first message.

The server may determine the current cell of the UE based on the cell identity information used in the second message sent by the UE, or the UE may send indication information of the current cell to the server.

In some embodiments, the reception quality parameters include a reference signal received power (RSRP).

Here, the UE may measure RSRPs corresponding to different antenna combinations, and send the first message of the different antenna combinations and the RSRP to the server.

RSRP is an average value of RF transmission power of all reference signals in the passband, and is a parameter used to indicate strength of a wireless signal. Using RSRP as the reception quality parameter may more clearly reflect receiving capabilities of different antenna combinations.

A specific example is provided below in combination with any one of the above-mentioned embodiments. An information communication method may include the following steps.

1. After a UE stays in a cell, the UE sends a request for on-demand system information k to a base station, and the base station sends the system information k to the UE.

2. The system information k provides to the UE results of antenna selection or MIMO-related parameters after big data or AI architecture. The UE selects an antenna combination according to the system information k corresponding to the ID of a current cell.

3. If the system information does not provide the results of antenna selection or MIMO-related parameters, the UE makes a default selection.

4. As shown in FIG. 2, a terminal has M receiving antennas and N baseband paths. When the number M of antennas connected to a certain frequency band is greater than the number of processing links N, the terminal may select antennas according to different scenarios.

5. A data collection phase T of the UE is set. The UE first selects a receiving antenna range according to a frequency band. If the number of selectable antennas is still greater than N, antenna combinations are selected by default, antenna combination manners are changed within t time, and data in each group {cell-id, SSB-RSRP, antenna combination} is recorded.

6. Data in one or n groups of the antenna combinations is reported to the base station. The same UE continuously reports data, and a plurality of similar UEs report data for multiple times. A certain amount of user data collection is achieved.

7. The base station or the data server performs hierarchical quantization processing on RSRPs in the data, and performs grouping or hierarchical indexing on the RSRPs. RSRP index value=RSRP measurement value/K, where K is a quantization constant.

8. After moment T, for a given cell, the base station collects enough data for processing and then send a corresponding table of SSB-RSRPs and the antenna combinations to the UE in the cell. The corresponding table of SSB-RSRPs and the antenna combinations may be shown in Table 1. After receiving the corresponding table, the UE stops the antenna selections in steps 1 and 2, and performs antenna combination selection based on a measured SSB-RSRP quantization value according to the above-mentioned table. A RSRP index value range will not allow the UE to frequently select antenna combinations, and one RSRP index value may correspond to two antenna combinations. In this way, the antenna combination selection may be performed twice in one cell.

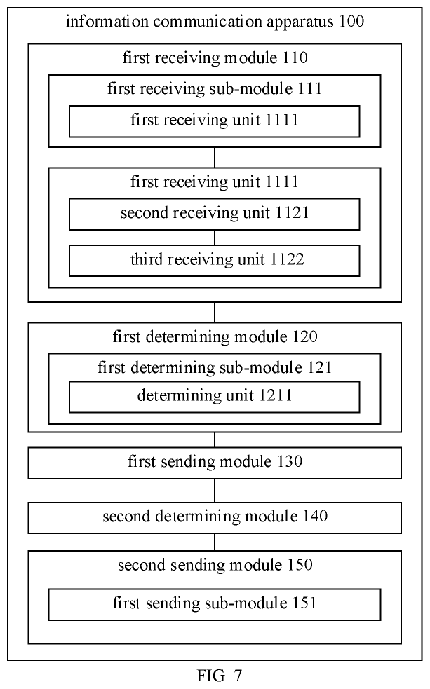

Embodiments of the present disclosure further provide an information communication apparatus, which is applied to a user equipment (UE) for wireless communication. As shown in FIG. 7, the information communication apparatus 100 includes a first receiving module 110 and a first determining module 120.

The first receiving module 110 is configured to receive multi-antenna selection reference information sent by a base station.

The first determining module 120 is configured to determine antenna combinations for wireless communication based on the multi-antenna selection reference information.

In some embodiments, antennas in different antenna combinations are not completely the same or are completely different, and/or signal receiving paths in the different antenna combinations are not completely the same or are completely different.

In some embodiments, the first receiving module 110 includes a first receiving sub-module 111 configured to receive system information carrying the multi-antenna selection reference information sent by the base station.

In some embodiments, the information communication apparatus 100 further includes a first sending module 130 configured to send a system information request to the base station.

The first receiving sub-module 111 includes a first receiving unit 1111 configured to receive the system information carrying the multi-antenna selection reference information sent by the base station in response to the system information request.

In some embodiments, the first receiving module 110 at least includes a second receiving sub-module 112 configured to receive a first message sent by the base station for identifying at least two antenna combinations and corresponding reception quality parameters.

The first determining module 120 includes a first determining sub-module 121 configured to determine the antenna combinations for the wireless communication according to the first message.

In some embodiments, the information communication apparatus 100 further includes a second determining module 140 and a second sending module 150.

The second determining module 140 is configured to determine reception quality parameters of the at least two antenna combinations.

The second sending module 150 is configured to send a second message for identifying the at least two antenna combinations and the reception quality parameters determined to the base station. The second message is configured to determine the first message.

In some embodiments, the second message is further used to indicate a cell corresponding to the second message.

In some embodiments, the second sending module 150 includes a first sending sub-module 151 configured to send one or more second messages obtained by one or more times to the base station.

In some embodiments, the second receiving sub-module 112 includes a second receiving unit 1121 configured to receive the first message sent by the base station for identifying the at least two antenna combinations and corresponding reception quality parameter index values. Different quality parameter index values represent different ranges of the reception quality parameters.

In some embodiments, the reception quality parameter index values are obtained by rounding quotients that are obtained by dividing the reception quality parameters by a predetermined quantization constant.

In some embodiments, the second receiving sub-module 112 includes a third receiving unit 1122 configured to receive the first message in a current cell.

The first determining sub-module 121 includes a determining unit 1211 configured to antenna combinations for wireless communication for the current cell according to the first message in the current cell.

In some embodiments, the reception quality parameters include a reference signal received power (RSRP).

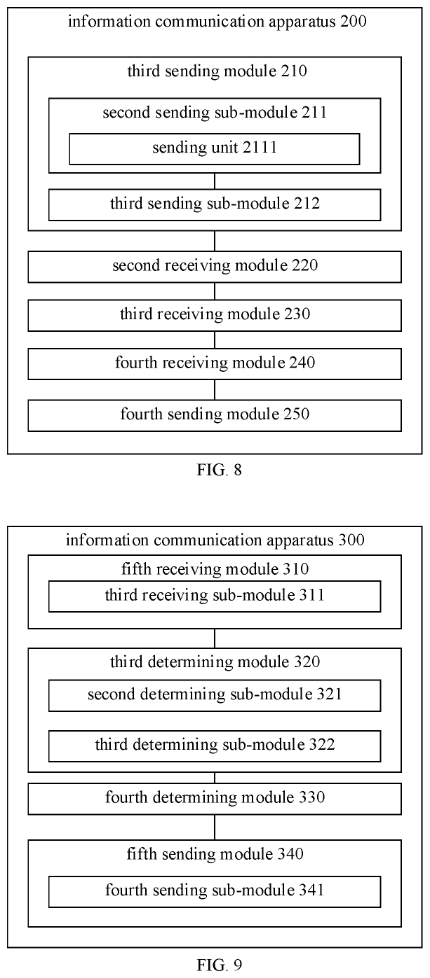

Embodiments of the present disclosure further provide an information communication apparatus, which is applied to a base station for wireless communication. As shown in FIG. 8, the information communication apparatus 200 include a third sending module 210.

The third sending module 210 is configured to send multi-antenna selection reference information to a UE. The multi-antenna selection reference information is configured to determine antenna combinations for wireless communication by the UE.

In some embodiments, antennas in different antenna combinations are not completely the same or are completely different, and/or signal receiving paths in the different antenna combinations are not completely the same or are completely different.

In some embodiments, the third sending module 210 includes a second sending sub-module 211 configured to send system information carrying the multi-antenna selection reference information to the UE.

In some embodiments, the information communication apparatus 200 further includes a second receiving module 220 configured to receive a system information request sent by the UE.

The second sending sub-module 211 includes a sending unit 2111 configured to send the system information carrying the multi-antenna selection reference information to the UE in response to receiving the system information request.

In some embodiments, the third sending module 210 at least includes a third sending sub-module 212 configured to send a first message for identifying at least two different antenna combinations and reception quality parameters to the UE.

In some embodiments, the information communication apparatus 200 further includes a third receiving module 230 configured to receive the first message sent by a server.

In some embodiments, the information communication apparatus 200 further includes a fourth receiving module 240 configured to receive a second message sent by the UE. The second message is configured to identify at least two antenna combinations and reception quality parameters of the at least two antenna combinations determined by the UE.

The first message is determined based on the second message.

In some embodiments, the information communication apparatus 200 further includes a fourth sending module 250 configured to send the second message to the server.

In some embodiments, the reception quality parameters include a reference signal received power (RSRP).

Embodiments of the present disclosure further provide an information communication apparatus, which is applied to a server for wireless communication. As shown in FIG. 9, the information communication apparatus 300 includes a fifth receiving module 310.

The fifth receiving module 310 is configured to receive a second message of at least one UE that is sent by a base station and configured to identify at least two antenna combinations and reception quality parameters.

In some embodiments, antennas in different antenna combinations are not completely the same or are completely different, and/or signal receiving paths in the different antenna combinations are not completely the same or are completely different.

In some embodiments, the information communication apparatus 300 further includes a third determining module 320 configured to determine a first message of at least two antenna combinations and corresponding reception quality parameters based on the received second message of at least one UE.

In some embodiments, the information communication apparatus 300 further includes a fourth determining module 330 configured to determine a cell corresponding to the second message according to an indication of the second message.

The third determining module 320 includes a second determining sub-module 321 configured to determine the first message of the cell corresponding to the second message according to the second message.

In some embodiments, the third determining module 320 includes a third determining sub-module 322 configured to determine the first message of at least two antenna combinations and corresponding reception quality parameter index values based on the second message. Different quality parameter index values represent different ranges of reception quality parameters.

In some embodiments, the reception quality parameter index values are obtained by rounding quotients that are obtained by dividing the reception quality parameters by a predetermined quantization constant.

In some embodiments, the fifth receiving module 310 includes a third receiving sub-module 311 configured to receive one or more of the second messages determined by the at least one UE for one or more times.

In some embodiments, the information communication apparatus 300 further includes a fifth sending module 340 configured to send a first message to the base station. The first message is configured to determine the antenna combinations for wireless communication by the UE.

In some embodiments, the fifth sending module 340 includes a fourth sending sub-module 341 configured to send a first message corresponding to a current cell of the UE to the base station. The first message is configured to determine antenna combinations for wireless communication in the current cell by the UE.

In some embodiments, the reception quality parameters include a reference signal received power (RSRP).

In some embodiments, the above-mentioned modules may be implemented by one or more central processing units (CPU), graphics processing units (GPU), baseband processors (BP), application specific integrated circuits (ASIC), DSPs, programmable logic devices (PLD), complex programmable logic devices (CPLD), field programmable gate arrays (FPGA), general-purpose processors, controllers, microcontroller units (MCU), microprocessors, or other electronic elements, for performing the above-mentioned information communication methods.

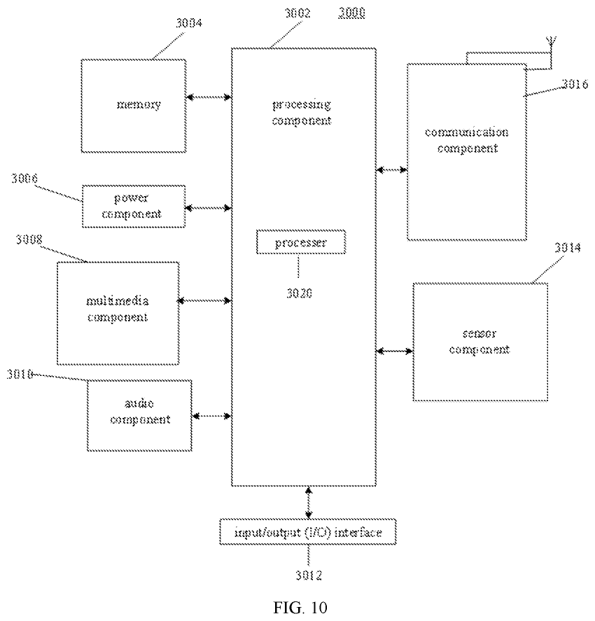

FIG. 10 is a block diagram illustrating a device 3000 for information communication according to an illustrative embodiment. For example, the device 3000 may be a mobile phone, a computer, a digital broadcast terminal, a messaging device, a game console, a tablet device, a medical device, a fitness device, a personal digital assistant, and the like.

Referring to FIG. 10, the device 3000 may include one or more of the following components: a processing component 3002, a memory 3004, a power component 3006, a multimedia component 3008, an audio component 3010, an input/output (I/O) interface 3012, a sensor component 3014, and a communication component 3016.

The processing component 3002 generally controls the overall operations of the device 3000, such as operations associated with display, telephone calls, data communications, camera operations, and recording operations. The processing component 3002 may include one or more processors 3020 to execute instructions to complete all or part of the steps of the above-mentioned methods. In addition, the processing component 3002 may include one or more modules to facilitate the interaction between processing component 3002 and other components. For example, processing component 3002 may include a multimedia module to facilitate the interaction between multimedia component 3008 and the processing component 3002.

The memory 3004 is configured to store various types of data to support the operation of the device 3000. Examples of these data include instructions for any application or method operating on the device 3000, e.g., contact data, phonebook data, messages, pictures, videos and the like. The memory 3004 may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power component 3006 provides power to various components of the device 3000. The power components 3006 may include a power management system, one or more power sources, and other components associated with the generation, management, and distribution of power in the device 3000.

The multimedia component 3008 includes a screen that provides an output interface between the device 3000 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touches, slides, and gestures on the touch panel. The touch sensor may not only sense a boundary of a touch or slide action, but also detect duration and pressure associated with the touch or slide action. In some embodiments, the multimedia component 3008 includes a front camera and/or a rear camera. When the device 3000 is in an operation mode, such as a shooting mode or a video mode, the front camera and/or the rear camera may receive external multimedia data. Each of the front camera and the rear camera may be a fixed optical lens system or have focal and optical zoom capability.

The audio component 3010 is configured to output and/or input audio signals. For example, the audio component 3010 includes a microphone (MIC). When the device 3000 is in an operation mode, such as a call mode, a recording mode, and a voice recognition mode, the microphone is configured to receive external audio signals. The received audio signals may be further stored in the memory 3004 or transmitted via the communication component 3016. In some embodiments, the audio component 3010 further includes a speaker for outputting audio signals.

The I/O interface 3012 provides an interface between the processing component 3002 and a peripheral interface module. The peripheral interface module may be keyboards, click wheels, buttons or the like. These buttons may include, but are not limited to, a home button, a volume button, a start button, and a lock button.

The sensor component 3014 includes one or more sensors for providing the device 3000 with status assessments in various aspects. For example, the sensor component 3014 may detect the on/off status of the device 3000 and the relative positioning of components. For example, the component is the display and the keypad of the device 3000. The sensor component 3014 may also detect the position change of the device 3000 or a component of the device 3000, the presence or absence of contact between the user and the device 3000, the orientation or acceleration/deceleration of the device 3000, and the temperature change of the device 3000. The sensor assembly 3014 may include a proximity sensor configured to detect the presence of nearby objects without any physical contact. The sensor component 3014 may also include a light sensor, such as a CMOS or CCD image sensor, for imaging applications. In some embodiments, the sensor component 3014 may also include an acceleration sensor, a gyroscope sensor, a magnetic sensor, a pressure sensor or a temperature sensor.

The communication component 3016 is configured to facilitate wired or wireless communication between the device 3000 and other devices. The device 3000 may access wireless networks based on communication standards, such as Wi-Fi, 2G, 3G, or a combination thereof. In an illustrative embodiment, the communication component 3016 receives broadcast signals or broadcast related information from an external broadcast management system via a broadcast channel. In an illustrative embodiment, the communication component 3016 further includes a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology and other technologies.

In an illustrative embodiment, the device 3000 may be implemented by one or more application specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic elements, for performing the above-mentioned methods.

In an illustrative embodiment, there is also provided a non-transitory computer-readable storage medium having stored therein instructions, such as a memory 3004 including instructions, which may be executed by the processor 3020 of the device 3000 to implement the above-mentioned methods. For example, the non-transitory computer readable storage medium may be a ROM, a random access memory (RAM), a CD-ROM, a magnetic tape, a floppy disc, an optical data storage device or the like.

Other embodiments of the present disclosure will be apparent to those skilled in the art from consideration of the specification and practice of the present disclosure described here. The present disclosure is intended to cover any variations, uses, or adaptations of the embodiments of the present disclosure following the general principles thereof and including such departures from the embodiments of the present disclosure as come within known or customary practice in the art. It is intended that the specification and examples be considered as exemplary only, with a true scope and spirit of the embodiments of the present disclosure being indicated by the following claims.

It will be appreciated that the embodiments of the present disclosure are not limited to the exact construction that has been described above and illustrated in the accompanying drawings, and that various modifications and changes can be made without departing from the scope thereof. It is intended that the scope of the embodiments of the present disclosure only be limited by the appended claims.

1. An information communication method, applied to a user equipment (UE), comprising:
receiving multi-antenna selection reference information sent by a base station;
determining antenna combinations for wireless communication based on the multi-antenna selection reference information.

2. The method according to claim 1, wherein antennas in any two different antenna combinations are not completely the same or are completely different, and/or signal receiving paths in any two different antenna combinations are not completely the same or are completely different.

3. The method according to claim 1, wherein receiving the multi-antenna selection reference information sent by the base station comprises:
receiving system information carrying the multi-antenna selection reference information sent by the base station.

4. The method according to claim 3, further comprising:
sending a system information request to the base station;
wherein receiving the system information carrying the multi-antenna selection reference information sent by the base station comprises:
receiving the system information carrying the multi-antenna selection reference information sent by the base station in response to the system information request.

5. The method according to claim 1, wherein receiving the multi-antenna selection reference information sent by the base station at least comprises:
receiving a first message sent by the base station for identifying at least two antenna combinations and corresponding reception quality parameters;
wherein determining the antenna combinations for the wireless communication based on the multi-antenna selection reference information comprises:
determining the antenna combinations for the wireless communication according to the first message.

6. The method according to claim 5, further comprising:
determining reception quality parameters of the at least two antenna combinations;
sending a second message for identifying the at least two antenna combinations and the reception quality parameters determined to the base station;
wherein the second message is configured to determine the first message.

7. The method according to claim 6, wherein the second message is further configured to indicate a cell corresponding to the second message.

8. The method according to claim 6, wherein sending the second message for identifying the at least two antenna combinations and the reception quality parameters determined to the base station comprises:
sending, to the base station, one or more second messages obtained by one or more measurements.

9. The method according to claim 5, wherein receiving the first message sent by the base station for identifying at least two antenna combinations and corresponding reception quality parameters comprises:
receiving the first message sent by the base station for identifying the at least two antenna combinations and corresponding reception quality parameter index values;
wherein any two different quality parameter index values represent different ranges of the reception quality parameters.

10. The method according to claim 9, wherein the reception quality parameter index values are obtained by rounding quotients that are obtained by dividing the reception quality parameters by a predetermined quantization constant.

11. The method according to claim 5, wherein receiving the first message sent by the base station for identifying at least two antenna combinations and corresponding reception quality parameters comprises:
receiving the first message in a current cell;
determining the antenna combinations for the wireless communication according to the first message comprises:
determining antenna combinations for wireless communication for the current cell according to the first message in the current cell.

12. The method according to claim 5, wherein the reception quality parameters comprise a reference signal received power (RSRP).

13-62. (canceled)

63. A communication device, comprising:
a processor; and
a memory for storing executable programs capable of being run by the processor;
wherein the processor is configured to;
receive multi-antenna selection reference information sent by a base station;
determine antenna combinations for wireless communication based on the multi-antenna selection reference information.

64. A storage medium having stored therein executable programs that, when executed by a processor, cause the processor to:
receive multi-antenna selection reference information sent by a base station;
determine antenna combinations for wireless communication based on the multi-antenna selection reference information.

65. The communication device according to claim 63, wherein the processor is further configured to:
receive system information carrying the multi-antenna selection reference information sent by the base station.

66. The communication device according to claim 65, wherein the processor is further configured to:
send a system information request to the base station;
wherein the processor is further configured to:
receive the system information carrying the multi-antenna selection reference information sent by the base station in response to the system information request.

67. The communication device according to claim 63, wherein the processor is further configured to:
receive a first message sent by the base station for identifying at least two antenna combinations and corresponding reception quality parameters;
wherein the processor is further configured to:
determine the antenna combinations for the wireless communication according to the first message.

68. The communication device according to claim 67, wherein the processor is further configured to:
determine reception quality parameters of the at least two antenna combinations;
send a second message for identifying the at least two antenna combinations and the reception quality parameters determined to the base station;
wherein the second message is configured to determine the first message.

69. The communication device according to claim 68, wherein the processor is further configured to:
send one or more of the second messages measured one or more times to the base station.

70. The communication device according to claim 67, wherein the processor is further configured to:
receive the first message sent by the base station for identifying the at least two antenna combinations and corresponding reception quality parameter index values;
wherein any two different quality parameter index values represent different ranges of the reception quality parameters.
